(19) United States
(12) Patent Application Publication
(10) Pub. No.: US 2011/0240319 A1
(43) Pub. Date: Oct. 6, 2011

(54) SHALLOW CONCAVITY SCALLOPED DISC BLADE

(75) Inventor: Donald J. Sanderson, Puslinch (CA)

(73) Assignee: CANYON STREET CROSSING LIMITED LIABILITY COMPANY, Boulder, CO (US)

(21) Appl. No.: 12/750,986

(22) Filed: Mar. 31, 2010

(51) Int. Cl. A01B 23/06

(52) U.S. Cl. 172/604

(57) ABSTRACT

A shallow concavity scalloped disc blade particularly suitable for vertical tillage applications is disclosed. The disc blade comprises a generally circular plate having a peripheral radially toothed cutting edge, a smooth central portion configured to mountingly engage a harrow or like agricultural implement, and a curved scalloped (or fluted) portion adjacent to the central portion, the curved scalloped (or fluted) portion having a plurality of scallops formed between the flat central portion and the edge. The radius of curvature of the curved scalloped (or fluted) portion preferably is between about 850 mm and about 1000 mm, and more preferably about 900 mm.

### BACKGROUND OF THE INVENTION

The present invention relates generally to agricultural equipment, and more particularly to a shallow concavity scalloped disc blade for use with harrows and like agricultural implements for tilling soil. The shallow concavity scalloped disc blade of the present invention is particularly suitable for use in vertical tillage applications.

Disc blades have been used in the agricultural industry for decades. Typically such devices are attached to a harrow or like agricultural implement and are pulled through the soil while being caused to rotate. The rotating blade engages the soil as it passes through the soil, thereby working the soil (leveling, breaking up, burying residue, etc.), generally in preparation for planting and/or for seasonal soil maintenance.

Prior art disc blades traditionally have been made in numerous configurations. However, nearly all such prior art blades typically have a generally round (disc-like) shape with either a generally flat or a generally concave central portion configured with a hole or other opening, or openings, configured to mount the blade to a harrow or like agricultural implement. Many of the other features of such blades can vary depending on the nature of the particular tilling application and the characteristics of the soil being tilled (such as the hardness of the soil, the presence of rocks or other content, and/or the presence of certain types of agricultural residue).

For example, some prior art blades have a generally smooth surface. However, other blades are formed with surface deformations, such as flutes, ridges, grooves, scallops, waves and the like that are designed to cut and move the soil in a manner that results in the desired soil condition.

Similarly, some prior art blades comprise a generally circular edge (or perimeter or periphery), while other blades incorporate various edge geometries and/or deformations, such as notches, grooves, bevels, teeth, saw-teeth and like structures that are adapted to address various types of soils and tilling conditions.

As is known to those skilled in the art, prior art disc blades have been made in various diameters, ranging from diameters of about 8 inches to diameters of about 36 inches, depending on the geometry and configuration of the particular blade, the nature of the particular tilling application and the characteristics of the soil being tilled. Similarly, prior art blades typically have been made either as flat blades (having essentially zero concavity) or as high concavity blades (having radii of curvature in the range of about 600-750 mm) In this context, the radius of curvature of the blade refers to degree of curvature of the curved portion of the blade

One particular disc blade that has been developed in the art is a scalloped or fluted disc blade with a radially toothed cutting edge or outer periphery (the edge comprises teeth having a generally radially sinusoidal, or wavy, geometry). This prior art blade comprises a generally circular plate having a peripheral radially toothed cutting edge, a smooth (non-scalloped or non-fluted) central portion configured to mountingly engage a harrow or like agricultural implement, and a curved scalloped (or fluted) portion having a plurality of scallops, flutes or waves formed by a plurality of adjacent crests and valleys disposed between the smooth central portion and the radially toothed edge.

In this particular prior art blade, the plurality of crests (as viewed from the convex side of the blade) extend radially from the central portion of the blade at a distance that is further than the distance that the plurality of valleys (as viewed from the convex side of the blade) extend from the central portion of the blade. In this manner, a radially toothed cutting edge is formed along the outer periphery of the blade. The geometry of this radially toothed edge advantageously provides for improved soil and residue cutting performance while at the same time providing the blade with the ability to self-sharpen with ongoing use.

That is, as the blade wears with use, and the diameter of the blade decreases, the structure of the blade provides that the crests and valleys will wear generally evenly, maintaining the radially toothed profile of the outer periphery of the blade instead of wearing unevenly and creating a generally smooth outer periphery over a period of extended use. Thus, with wear, the edge of the blade will generally maintain its radially toothed profile instead of becoming smooth (non-toothed), as has been the case with other prior art disc blade designs. This allows the blade to be continually sharpened to permit its continued use.

As appreciated by those skilled in the art, the precise number and depth the of scallops (i.e., the crests and valleys) may vary depending on the diameter of the blade, the nature of the particular tilling application and the characteristics of the soil being tilled (such as the hardness of the soil, the presence of rocks or other content, and/or the presence of certain types of agricultural residue). For example, a common 20 inch blade may have 32 scallops formed by the plurality of adjacent crests and valleys, and each scallop may have a depth of between 6 and 9 mm (this distance from the top of one crest to the bottom of an adjacent valley). However, numerous variations in the number of scallops and their depth are possible.

This particular prior art blade, which is well known in the art and has been commercially available for years under various brand names from various manufacturers, traditionally has been formed in a high concavity configuration. That is, the curved scalloped (or fluted) portion of the blade has a radius of curvature in the range of about 600-750 mm, meaning the overall concavity of the blade is relatively high (i.e., the blade has a deep concavity).

For example, in a common 20 inch (508 mm) diameter size of a flat center portion version of this prior art blade, the concavity is about 2 inches (or 51 mm), and in a common 22 inch (260 mm) diameter version of such a blade, the concavity is about 2.17 inches (or 55 mm). And, in a 36 inch (or 915 mm) diameter size of such a blade, the concavity is about 5.12 inches (or 130 mm) As noted above, the radii of curvature of the curved scalloped (or fluted) portion of such prior art blades typically ranges from about 600 mm to about 750 mm, meaning the blades have a relatively deep concavity or dish shape.

Traditionally, tilling has been accomplished using horizontal tillage methods and apparatuses as are well known to those skilled in the art. In recent years, however, the agricultural industry has embraced a relatively new type of tilling known as vertical tillage. Vertical tillage involves the use of disc blades configured in a generally vertical orientation relative to the soil. That is, the blades are mounted such that the edge or outer periphery of the blade is perpendicular or transverse to the horizontal plane of the soil. Those skilled in the art are well versed in the advantages of vertical tillage over horizontal tillage, however, one of the major advantages of vertical tillage is the ability to cut, size and bury residue.

Because vertical tillage applications involve relatively high speed and relatively shallow depth use of disc blade, as compared to horizontal tillage applications, prior art disc blades designed for use in prior art horizontal tillage applications are not suitable for use in vertical tillage systems. That is, many such prior art disc blade designs would create undesirable side effects if used in vertical tillage applications, such as unacceptable soil throw. Additionally, many prior art disc blade designs do not have a sufficiently sharp edge for cutting, sizing and burying residue.

What is needed, therefore, is a new disc blade that is particularly suitable for use in vertical tillage applications. Preferably, such a disc blade comprises a scalloped or fluted disc blade with a radially toothed edge or outer periphery. More preferably, such a disc blade comprises a flat or concave smooth central portion configured to mountingly engage a harrow or like agricultural implement, and a curved scalloped portion adjacent to the central portion, the curved scalloped portion having plurality of scallops formed by a plurality of adjacent crests and valleys disposed between the flat central portion and the radially toothed edge. More preferably still, the curved scalloped portion has a high radius of curvature that has not heretofore been applied to prior art blades having a similar design. The present invention satisfies this need.

### BRIEF SUMMARY OF THE INVENTION

The present invention comprises a shallow concavity scalloped disc blade for use with harrows and like agricultural implements for tilling soil. The shallow concavity scalloped disc blade of the present invention is particularly suitable for use in vertical tillage applications

The disc blade of the present invention comprises a generally circular plate having a peripheral radially toothed cutting edge, a smooth central portion configured to mountingly engage a harrow or like agricultural implement, and a curved scalloped (or fluted) portion adjacent to the central portion, the curved scalloped portion having a plurality of scallops (or flutes or waves) formed by a plurality of adjacent crests and valleys disposed between the flat central portion and the radially toothed edge. The smooth central portion may be generally flat or curved (concave).

Preferably, the plurality of crests (as viewed from the convex side of the blade) extend radially from the central portion of the blade at a distance that is greater than the distance that the plurality of valleys (as viewed from the convex side of the blade) extend from the central portion of the blade. In this manner, a radially toothed cutting edge is formed along the outer periphery of the blade.

Unlike prior art disc blades, the disc blade of the present invention is formed with a generally shallow concavity. In this sense, concavity is derived from the radius of curvature of the curved scalloped (or fluted) portion of the blade.

In the preferred embodiment of the shallow concavity scalloped disc blade of the present invention, the radius of curvature of the curved scalloped (or fluted) potion of the blade ranges from about 850 mm to about 1000 mm and, more preferably about 900 mm. Such shallow concavities are not known in the art for such scalloped disc blades.

It has been found that the particular shallow concavity ranges of the scalloped blades of the present invention advantageously allows such blades to be used in high speed, low depth vertical tillage applications in a manner that adequately tills particularly tough soil clods while minimizing the amount of soil undesirably thrown by such blades and adequately cutting, sizing and burying residue.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a front perspective view of concave side of the shallow concavity scalloped disc blade embodying the principles of the present invention;

FIG. 2 is a front perspective view of the shallow concavity scalloped disc blade embodying the principles of the present invention;

FIG. 3 is a fragmentary view of the radially toothed cutting edge of the shallow concavity scalloped disc blade embodying the principles of the present invention as shown in Section A of FIG. 1;

FIG. 4 is an enlarged, cross-sectional, fragmentary view of the curved scalloped (or fluted) portion of the shallow concavity scalloped disc blade embodying the principles of the present invention as shown in Section B of FIG. 2; and,

FIG. 5 is an enlarged, cross-sectional fragmentary view of the radially toothed cutting edge of the shallow concavity scalloped disc blade embodying the principles of the present invention taken long the line C-C of FIG. 1.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description of the Invention,” relates to a requirement of the United States Patent Office, and does not imply, nor should be inferred to limit the subject matter disclosed herein.

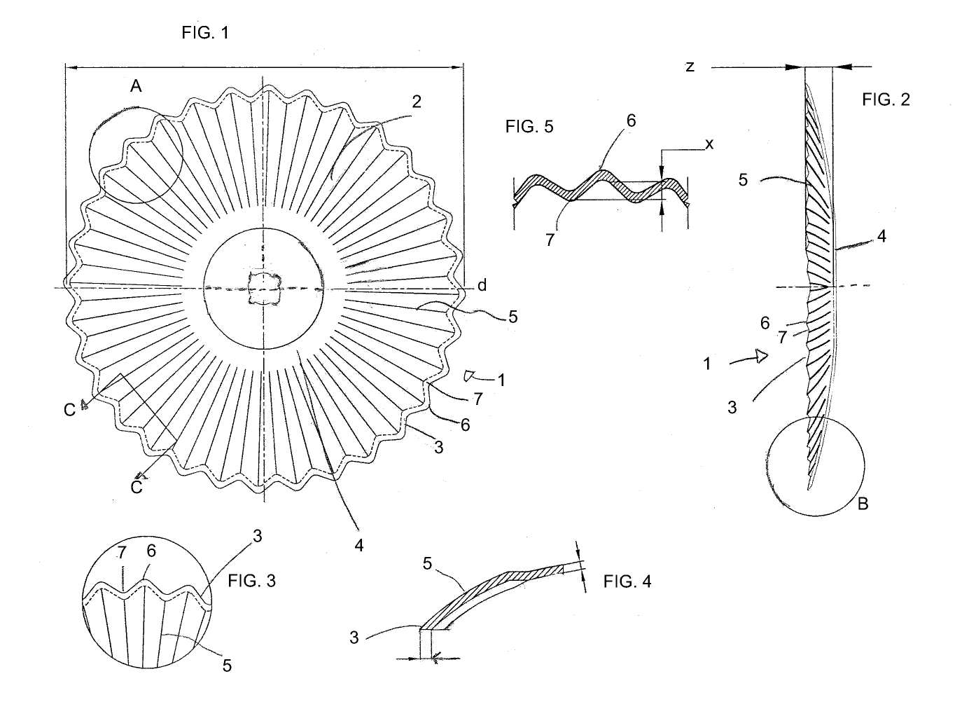

FIGS. 1-5 illustrate the shallow concavity scalloped disc blade 1 according to the principles of the present invention. Disc blade 1 of the present invention is configured for use with harrows and like agricultural implements for tilling soil, and is particularly suitable for use in vertical tillage applications.

Disc blade 1 of the present invention preferably is comprised of steel or other suitable materials as are known to those skilled in the art, and is formed using methods and techniques well known to those skilled in the art. All such materials, methods and techniques are included within the scope of the instant disclosure, and may be utilized with disc blade 1 without departing from the scope of the instant disclosure.

As shown in FIG. 1, shallow concavity scalloped disc blade 1 preferably comprises a generally circular plate 2 having a peripheral radially toothed cutting edge 3, a smooth (i.e., non-scalloped) central portion 4 configured to mountingly engage a harrow or like agricultural implement (not shown), and a curved scalloped (or fluted) portion 5 having plurality of scallops (or flutes or waves) formed by a plurality of adjacent crests 6 and valleys 7 disposed between central portion 4 and the edge 3 of disc blade 1. Curved scalloped (or fluted) portion 5 has a slight arcuate shape such that disc blade 1 has a slight bowl-shaped profile, as most clearly seen in FIG. 2.

While the illustrated disc blade 1 depicts smooth central portion 4 as generally flat, it will be appreciated that smooth central portion 4 alternatively may be concave, depending on the particular agricultural implement to which disc blade 1 may be attached. All such configurations of smooth central portion 4 are included with the scope of the present disclosure.

As appreciated by those skilled in the art, the precise number and depth of scallops in curved scalloped (or fluted) portion 5 may vary depending on the diameter of blade 1, the nature of the particular tilling application and the characteristics of the soil being tilled (such as the hardness of the soil, the presence of rocks or other content, and/or the presence of certain types of agricultural residue).

By way of example only, FIG. 1 depicts a disc blade 1 having 32 scallops formed by the plurality of adjacent crests 6 and valleys 7. Such a configuration is typical for disc blades having a diameter of 20 inches, a popular size for such blades. However, both the diameter d of disc blade 1 and the number of scallops may vary without departing from the scope of the instant disclosure, and all such variations are included within the scope of the present invention.

Additionally, as shown in FIG. 5, each scallop has a depth x as measured from the top of one crest 6 to the bottom of an adjacent valley 7. In the preferred embodiment of disc blade 1 of the present invention, the depth x of each scallop is in the range of between about 6 mm and 9 mm. However, again, variations in the depth x of scallops are included within the scope of the instant disclosure, and those skilled in the art will appreciate the many variations that may be used for disc blade 1.

Further, as shown most clearly in FIG. 1 and FIG. 3, edge 3 preferably is beveled to enhance the sharpness of edge 3 and to better cut, size and bury residue. The bevel on edge 3 may be cut or ground into disc blade 1, or created using other techniques as are known to those skilled in the art.

In the preferred embodiment of the present invention, the plurality of crests 6 (as viewed from the convex side of blade 1) extend radially from central portion 4 of blade 1 at a distance that is greater than the distance that the plurality of valleys 7 (as viewed from the convex side of blade 1) extend from central portion 4 of blade 1. In this manner, radially toothed cutting edge 3 is formed along the outer periphery of blade 1. The benefits of the combination of scallops and radially toothed cutting edge 3 are well known to those skilled in the art, as discussed above.

In particular, as disc blade 1 wears with use, and diameter d of disc blade 1 decreases, crests 6 and valleys 7 will wear generally evenly, maintaining the radially toothed cutting edge 3 of disc blade 1 instead of wearing unevenly and creating a generally smooth (non-toothed) edge.

Unlike prior art disc blades, shallow concavity scalloped disc blade 1 of the present invention is formed with a generally shallow concavity. In this sense, concavity refers to the radius of curvature of the curved scalloped (or fluted) portion 5 of disc blade 1.

In the preferred embodiment of the shallow concavity scalloped disc blade of the present invention, the radius of curvature of curved scalloped (or fluted) potion 5 of disc blade 1 ranges from about 850 mm to about 1000 mm and, more preferably, about 900 mm. Such shallow concavities (high radii of curvature) are not known in the art for such scalloped disc blades.

As discussed above, it has been found that the particular shallow concavity of shallow concavity scalloped disc blade 1 of the present invention advantageously allow disc blade 1 to be used in high speed, low depth vertical tillage applications in a manner that adequately tills particularly tough soil clods while minimizing the amount of soil undesirably thrown by disc blade 1 and adequately cutting, sizing and burying residue.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A shallow concavity scalloped disc blade, comprising:
a generally circular plate having a diameter and a peripheral radially toothed cutting edge;
a smooth central portion; and
a curved scalloped portion adjacent to the smooth central portion, the curved scalloped portion having a plurality of scallops formed by a plurality of adjacent crests and valleys disposed between the central portion and the edge, each scallop having a depth measured from a top of the crest to a bottom of the valley forming the scallop, the depth being between about 6 mm and about 9 mm,
wherein the curved scalloped portion has a radius of curvature between about 850 mm and about 1000 mm.

2. The shallow concavity scalloped disc blade of claim 1, wherein the radius of curvature of the curved scalloped portion is about 900 mm.

3. The shallow concavity scalloped disc blade of claim 1, wherein the smooth central portion is substantially flat.

4. The shallow concavity scalloped disc blade of claim 1, wherein the smooth central portion is concave.

5. The shallow concavity scalloped disc blade of claim 1, wherein the central portion is configured to matingly engage an agricultural implement.

6. The shallow concavity scalloped disc blade of claim 1, wherein the plurality of crests extend radially from the central portion of the blade at a first distance that is greater than a second distance that the plurality of valleys extend from the central portion of the blade.

7. The shallow concavity scalloped disc blade of claim 1, wherein the edge is beveled.

8. The shallow concavity scalloped disc blade of claim 5, wherein the central portion comprises an opening for mounting the blade to the agricultural implement.

9. The shallow concavity scalloped disc blade of claim 5, wherein the central portion comprises a plurality of openings for mounting the blade to the agricultural implement.

10. The shallow concavity scalloped disc blade of claim 5, wherein the agricultural implement comprises a harrow.

11. The shallow concavity scalloped disc blade of claim 5, wherein the blade is configured to be mounted to the agricultural implement in a vertical orientation.
